(19) United States
(12) Patent Application Publication
(10) Pub. No.: US 2005/0157492 A1
(43) Pub. Date: Jul. 21, 2005

(54) Lighting device

(76) Inventor: Si Fu Chiu, Hong Kong (HK)

Correspondence Address: LEYDIG VOIT & MAYER, LTD, 700 THIRTEENTH ST. NW, SUITE 300, WASHINGTON, DC, 20005-3960, US

(21) Appl. No.: 10/759,116

(22) Filed: Jan. 20, 2004

(51) Int. Cl. F21L 4/02

(52) U.S. Cl. 362/184; 362/205; 362/187; 362/800; 362/231

(57) ABSTRACT

A lighting device has a body for holding a battery cell and a connected head that has a lens having several light deflecting portions. A number of light sources, such as super LEDs, are mounted within the head for energization by the battery cell to emit light through the lens, with light from the individual light sources being merged together by the light deflecting portions. A switch on the body switches on and off the light sources. The light sources comprise two groups of different colours. The head is rotatable relative to the light sources for aligning the light deflecting lens portions with the light sources of either one group selectively for merging the light of the corresponding colour from that group.

The present invention relates to a lighting device and in particular but not exclusively to a flashlight.

### BACKGROUND OF THE INVENTION

Lighting devices, and in particular flashlights or torches, typically have a body, a head connected thereto, and a light bulb in the head for emitting light through a lens in the head. There may be more than one light bulb in the head, especially the smaller ones that are energy efficient but not sufficiently bright on its own, such as super LEDs (light emitting diodes). Super LEDs are available in different colours and are becoming increasingly popular, but lighting devices utilising them for selective colour lighting are rare.

The subject invention seeks to provide a lighting device that meets the demand in this regard.

### SUMMARY OF THE INVENTION

According to the invention, there is provided a lighting device comprising a hollow body for holding a battery cell and a head connected to the body. The head includes a lens having a plurality of light deflecting portions. A plurality of light sources are mounted within the head for energization by the battery cell to emit light through the lens, with light from the individual light sources being merged together by the light deflecting portions. An electrical switch provided on the body for switching on and off the light sources. The light sources comprise at least first and second groups of different colours. The head is rotatable relative to the light sources for generally aligning the light deflecting lens portions with the light sources of either one group selectively for merging the light of the corresponding colour from that group.

Preferably, the switch has a first ON state for switching on the first group of light sources and a second ON state for switching on the second group of light sources.

More preferably, the switch includes a third ON state for switching on the second group of light sources to flash intermittently under the control of a flashing circuit that is provided in the body.

Further more preferably, the second group of light sources is of a red colour.

It is preferred that the light sources of the two groups are located in an alternating annular arrangement.

It is further preferred that the light deflecting lens portions are positioned in an annular arrangement that shares a common central axis with the light source arrangement.

In a preferred embodiment, the light sources are divided into two different colour groups, each of the same number of light sources, said number being also the number of the light deflecting lens portions.

In a specific construction, the light sources are fixed to the body, and the head is rotatable relative to the body.

Preferably, the light sources comprise light emitting diodes.

In a preferred embodiment, the lighting device is a flashlight, in which the body comprises a barrel having a front end to which the head is connected by screw-threads that permit said relative rotation of the head.

### BRIEF DESCRIPTION OF DRAWINGS

The invention will now be more particularly described, by way of example only, with reference to the accompanying drawings, in which:

FIG. 1 is a cross-sectional side view of an embodiment of a lighting device in accordance with the invention; and

FIG. 2 is a front end view of the lighting device of FIG. 1.

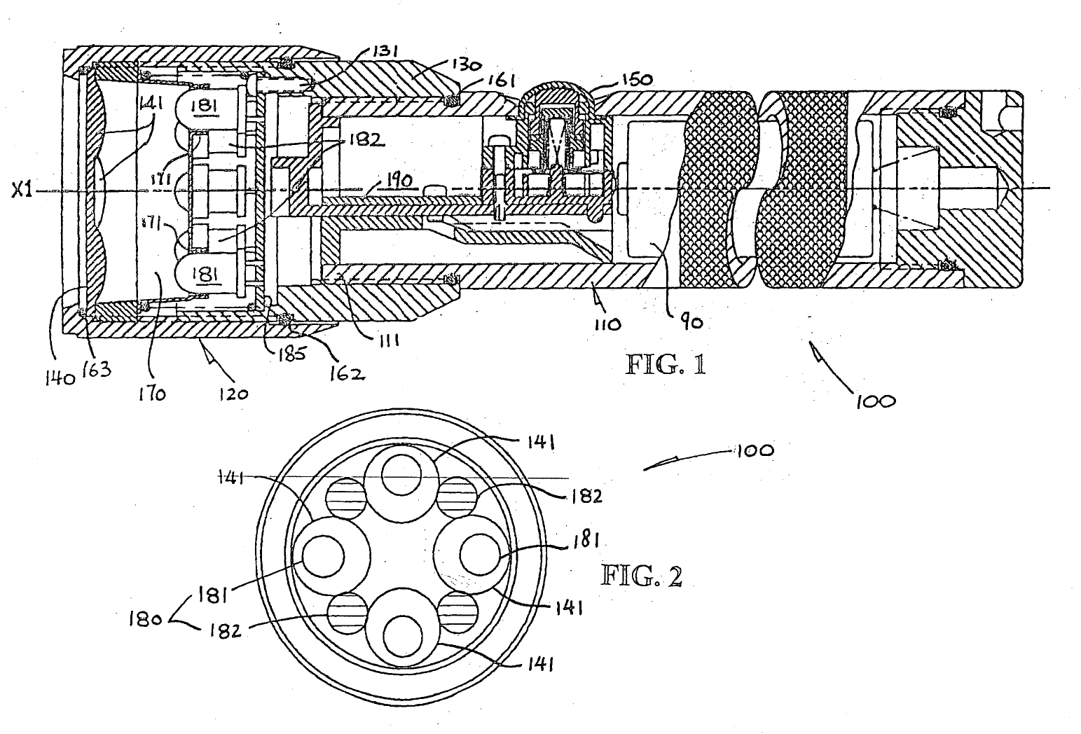

### DETAILED DESCRIPTION OF PREFERRED EMBODIMENT

Referring to the drawings, there is shown a lighting device in the form of a flashlight 100 embodying the invention, which comprises a cylindrical aluminium body barrel 110 for grasping by a hand and providing a battery compartment for holding a series of battery cells 90. The flashlight 100 includes a cylindrical aluminium head cap 120 that is connected co-axially to a front end 111 of the barrel 110 by means of a cylindrical aluminium collar 130, all sharing a common central axis X1.

The collar 130 is screw-threaded onto the front end 111 of the barrel 110 and is sealed therewith by a rubber seal ring 161. The collar 130 normally stays fixed to the barrel 110. The head cap 120 is screw-threaded onto the collar 130, with another seal ring 162 used for sealing. Due to the screw-thread engagement, the head cap 120 is tightly rotatable relative to the collar 130 or the barrel 110.

The head cap 120 has an open foremost end closed by a circular lens 140 that is fixed and sealed therewith by a yet another seal ring 163. The lens 140 includes four focusing portions or sub-lenses 141 integrally moulded at equiangular positions. The sub-lenses 141 have respective thickened convex inner surfaces that are inclined or tilted marginally inwardly, each in a direction towards the central axis X1.

The flashlight 100 includes eight super LEDs 180 located within the head cap 120 for energization by the battery cells 90 to emit light through the lens 140. Also included is an electrical press switch 150 provided on the barrel 110 for switching on and off the LEDs 180. The LEDs 180 are mounted on a circular printed circuit board 185 that is in turn mounted co-axially over an outer end of the connecting collar 130 for example by screws 131. A light reflector cup 170 is located between the lens 140 and the LEDs 180 for collecting light from the latter, which includes eight rear holes 171 receiving the corresponding LEDs 180.

The LEDs 180 are arranged equiangularly in a circle about the central axis X1, and are divided into two groups 181 and 182, each of four, of different colours namely white and red that alternate or interlace with each other. The LEDs 181/182 of each group are connected together in a separate circuit for independent energization.

Through rotation of the head cap 120 about the collar 130, the lens 140 is rotatable relative to the LEDs 180. This is done for generally aligning the four sub-lenses 141 with the LEDs 181/182 of either group, given that they all lie in respective circles of generally the same size. While in alignment, the sub-lenses 141 focus and more importantly divert, by reason of them being tilted as described above, the light from the LEDs 181/182 close together thereby merging the light emitted from individual sources into a single beam for integral illumination as if the light were from a single source. The angle at which the sub-lenses 141 are tilted is very small and aims to focus and combine the light together at a normal illuminating distance of say 60 cm ahead of the flashlight 100.

The head cap 120 is rotated for selectively aligning the sub-lenses 141 with either one group of white/red LEDs 181/182, depending on which group is turned on or intended for use. The white LEDs 181 are for normal illumination, whereas the red LEDs 182 are usually used for signalling especially in case of emergency to call for help. To enhance signalling effect, there is included an electronic flashing circuit 190 located between the switch 150 and the LEDs 180 for intermittently flashing the red LEDs 182.

Thus, the flashlight 100 has three modes of operation, namely a first mode with the white LEDs 181 turned ON, a second mode with the red LEDs 182 turned ON, and a third mode with the red LEDs 182 turned ON but flashing. All the LEDs 180 can of course be turned OFF in a non-operating mode. To implement all these modes, the switch 150 is chosen to have three ON states and one OFF state upon repeated pressings. In the first or second ON state, the switch 150 connects the corresponding group of white or red LEDs 181/182 to the battery cells 90. In the third ON state, the switch 150 connects the red LEDs 182 to the battery cells 90 via the flashing circuit 190.

It is understood that the number of LEDs 180 in each colour group (e.g. five LEDs) is not important, and neither is the number of colour groups (e.g. three groups) that can be included. Also, the precise tilting angle of the sub-lenses 141 and accurate alignment between them and the LEDs 181/182 are both not critical, as the light is only for lighting purpose.

The invention has been given by way of example only, and various modifications of and/or alterations to the described embodiment may be made by persons skilled in the art without departing from the scope of the invention as specified in the appended claims.

1. A lighting device comprising:
a hollow body for holding a battery cell;
a head connected to the body and including a lens having a plurality of light deflecting portions;
a plurality of light sources mounted within the head for energization by said battery cell to emit light through the lens, with light from the individual light sources being merged together by the light deflecting portions; and
an electrical switch provided on the body for switching on and off the light sources;
wherein the light sources comprise at least first and second groups of different colours, and the head is rotatable relative to the light sources for generally aligning the light deflecting lens portions with the light sources of either one group selectively for merging the light of the corresponding colour from that group.

2. The lighting device as claimed in claim 1, wherein the switch has a first ON state for switching on the first group of light sources and a second ON state for switching on the second group of light sources.

3. The lighting device as claimed in claim 2, wherein the switch includes a third ON state for switching on the second group of light sources to flash intermittently under the control of a flashing circuit that is provided in the body.

4. The lighting device as claimed in claim 3, wherein the second group of light sources is of a red colour.

5. The lighting device as claimed in claim 1, wherein the light sources of the two groups are located in an alternating annular arrangement.

6. The lighting device as claimed in claim 5, wherein the light deflecting lens portions are positioned in an annular arrangement that shares a common central axis with the light source arrangement.

7. The lighting device as claimed in claim 1, wherein the light sources are divided into two different colour groups, each of the same number of light sources, said number being also the number of the light deflecting lens portions.

8. The lighting device as claimed in claim 1, wherein the light sources are fixed to the body, and the head is rotatable relative to the body.

9. The lighting device as claimed in claim 1, wherein the light sources comprise light emitting diodes.

10. The lighting device as claimed in claim 1, being a flashlight, wherein the body comprise a barrel having a front end to which the head is connected by screw-threads that permit said relative rotation of the head.
